(19) United States
(12) Patent Application Publication
(10) Pub. No.: US 2013/0222882 A1
(43) Pub. Date: Aug. 29, 2013

(54) POLYMER DISPERSANT FOR IMAGE DISPLAY PARTICLES, IMAGE DISPLAY PARTICLES, DISPERSION LIQUID FOR IMAGE DISPLAY PARTICLES, DISPLAY MEDIUM, AND DISPLAY DEVICE

(71) Applicants: FUJI XEROX CO., LTD., (US); FUJIFILM CORPORATION, (US)

(72) Inventors: Mieko SEKI, Kanagawa (JP); Daisuke NAKAYAMA, Kanagawa (JP); Naoki HIJI, Kanagawa (JP); Yasuo YAMAMOTO, Kanagawa (JP); Takashi KATO, Kanagawa (JP)

(73) Assignees: FUJIFILM CORPORATION, Tokyo (JP); FUJI XEROX CO., LTD., Tokyo (JP)

(21) Appl. No.: 13/718,322

(22) Filed: Dec. 18, 2012

(30) Foreign Application Priority Data
Feb. 27, 2012 (JP) 2012-040366

(51) Int. Cl. C08L 43/04; C08F 230/08; C08K 5/5419; G02F 1/167

(52) U.S. Cl. CPC C08L 43/04; G02F 1/167; C08F 230/08; C08K 5/5419
USPC 359/296; 526/279; 524/547; 524/268

(57) ABSTRACT

A polymer dispersant for image display particles, including a copolymer having a repeating unit derived from a polymer component with a silicone chain, a repeating unit derived from a hydrophobic polymer component other than the polymer component with a silicone chain, and a repeating unit derived from a polymer component with a polyalkylene glycol structure.

### CROSS-REFERENCE TO RELATED APPLICATION(S) This application is based on and claims priority under 35 U.S.C. §119 from Japanese Patent Application No. 2012-040366 filed on Feb. 27, 2012.

### BACKGROUND

1. Technical Field

The present invention relates to a polymer dispersant for image display particles, image display particles, a dispersion liquid for image display, a display medium, and a display device.

2. Related Art

For example, JP-A-9-188732 discloses a “water-based ink dispersant formed from a copolymer of silicone macromer, methacrylic acid (MAA) and a monomer with a (meth)acryloxy group”.

Further, JP-A-2002-338642 discloses a “polymer dispersant for image display particles formed from a copolymer of silicone macromere, methacrylate, and polyethylene glycol”.

Further JP-A-2006-124557 discloses a “water-based ink dispersant formed from a water-insoluble polymer configured by a monomer having carboxylic group (salt-forming group) and a hydrophobic monomer (styrene-based)”.

An object of the present invention is to provide a polymer dispersant for image display particles to improve the dispersion stability of image display particles.

### SUMMARY

(1) A polymer dispersant for image display particles, containing a copolymer having a repeating unit corresponding to a polymer component with a silicone chain, a repeating unit corresponding to a hydrophobic polymer component other than the polymer component with a silicone chain, and a repeating unit corresponding to a polymer component with a polyalkylene glycol structure.

### BRIEF DESCRIPTION OF THE DRAWINGS

Exemplary embodiments of the present invention will be described in detail based on the following figures, wherein:

FIG. 1 is a schematic view of a display device according to the present exemplary embodiment; and

FIGS. 2A and 2B is an explanatory view schematically illustrating the movement state of a particle group when a voltage is applied between the substrates of a display medium of the display device according to the present exemplary embodiment.

### DETAILED DESCRIPTION

An embodiment of the present invention as an example of the present invention will be described below.

### [Polymer Dispersant for Image Display Particles]

A polymer dispersant for image display particles (hereinafter referred to as a “polymer dispersant”) according to the present exemplary embodiment has a copolymer of a polymer component with a silicone chain, a hydrophobic polymer component other than the polymer component with the silicone chain, a polymer component with a polyalkylene glycol structure, and as necessary, a hydrophilic polymer component other than the polymer component with the polyalkylene glycol structure.

The polymer dispersant according to the present exemplary embodiment improves the dispersion stability of the image display particles through the above configuration.

In particular, if the copolymer configuring the polymer dispersant according to the present exemplary embodiment is a copolymer in which a hydrophilic polymer component other than the polymer component with a polyalkylene glycol structure is further polymerized, it is thought that adsorption to the image display particles is improved, and the dispersion stability of the image display particles is more easily improved.

Further, it is thought that since the polymer dispersant according to the present exemplary embodiment also improves the emulsification dispersion stability of the raw materials when preparing the image display particles, as a result, aggregation of the emulsion is suppressed, and monodispersed image display particles are more easily obtained.

Furthermore, with the display element and the display device including an image display particle dispersion liquid using the polymer dispersant according to the present exemplary embodiment, a display medium and a display device in which display defects due to a decrease in the dispersion stability of the image display particles (for example, a decrease in the display concentration due to particle precipitation, or the like) can be suppressed, are provided.

Details of the polymer dispersant according to the present exemplary embodiment will be described below.

Here, in the following description, descriptions such as “(meth)acrylate” are expressions including both “acrylate” and “methacrylate”, and the like.

(Polymer Component with Silicone Chain)

The polymer component with a silicone chain (monomer with a silicone chain) is a macromonomer with a silicone chain, and specific examples thereof include a dimethyl silicone monomer with a (meth)acrylate group on one terminal (the silicone compound shown by the following Structural Formula 1: for example, Silaplane: FM-0711, Fm-0721, FM-0725, and the like manufactured by JNC Corporation, X-22-174DX, X-22-2426, X-22-2475, and the like manufactured by Shin-Etsu Chemical Co., Ltd., and the like) and the like.

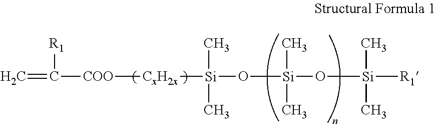

In Structural Formula 1, R₁ represents a hydrogen atom or a methyl group. R₁′ represents a hydrogen group or an alkyl group with from 1 to 4 carbon atoms. n represents a natural number (for example, from 1 to 1000, desirably from 3 to 100). x represents an integer from 1 to 3.

### (Hydrophobic Polymer Component)

The hydrophobic polymer component (hydrophobic monomer) is a polymer component other than the polymer component with a silicone chain, examples of which include alkylester(meth)acrylate (for example, methyl(meth)acrylate, ethyl(meth)acrylate, butyl(meth)acrylate, lauryl(meth)acrylate, and the like), olefin (for example, ethylene, butadiene, and the like), styrene, vinyl acetate, vinyl toluene, and the like.

(Polymer Component with Polyalkylene Glycol Structure)

The polymer component with the polyalkylene glycol structure is shown, for example, by the following General Formula (P).

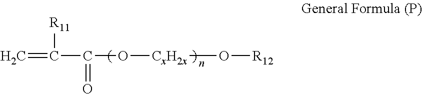

Here, in General Formula (P), x represents an integer from 1 to 3 (desirably an integer from 2 to 3).

n represents an integer from 1 to 40 (desirably an integer from 1 to 25, more desirably an integer from 5 to 20).

R₁₁ represents a hydrogen atom or a methyl group.

R₁₂ represents a hydrogen atom, an alkyl group with from 1 to 20 carbon atoms, a substituted, or an unsubstituted aromatic group (for example, a phenyl group, a phenyl group in which an alkyl group with from 1 to 3 carbon atoms is substituted, or the like).

Specific examples of polymer components with a polyalkylene glycol structure include methoxy poly(ethylene glycol)nacrylate, methoxy poly(ethylene glycol)nmethacrylate, nonylphenoxy poly(ethylene glybol)nacrylate, nonylphenoxy poly(ethylene glycol)nmethacrylate, stearyloxy poly(ethylene glycol)nacrylate, stearyloxy poly(ethylene glycol)nmethacrylate, and the like. Here, n represents the number of ethylene glycol.

### (Hydrophilic Polymer Component)

The hydrophilic polymer component (hydrophilic monomer) is a polymer component other than a polymer component with a polyalkylene glycol structure, and examples thereof include a polymer component with an acidic group, a polymer component with a hydroxyl group, and the like.

Examples of polymer components with an acidic group include a polymer component

Examples of the acidic group include a polymer component with a carboxylic group, a polymer component with a sulfonate group, a polymer component with a phosphoric acid group, and the like.

Examples of polymer components with a carboxylic group include (meth)acrylate, crotonic acid, itaconic acid, maleic acid, fumaric acid, citraconic acid, anhydrides thereof, monoalkyl esters or carboxyethylvinyl ethers thereof, vinyl ethers with a carboxylic group such as a carboxypropylvinyl ether, salts thereof, and the like.

Examples of polymer components with a sulfonate group include styrene sulfonate, 2-acrylamido-2-methylpropane sulfonate, 3-sulfopropyl(meth)acrylic acid ester, bis-(3-sulfopropyl)-itaconic acid ester, and the like, and salts thereof. Further, examples of polymer components with a sulfonate group also include sulfuric acid monoesters of 2-hydroxyethyl (meth)acrylates, and salts thereof.

Examples of polymer components with a phosphoric acid group include vinyl phosphonic acid, vinyl phosphate, acid phosoxyethyl(meth)acrylate, acid phosoxypropyl (meth)acrylate, bis(methacryloxyethyl)phosphate, diphenyl-2-methacryloyloxyethyl phosphate, diphenyl-2-acryloyloxyethyl phosphate, dibutyl-2-methacryloyloxyethyl phosphate, dibutyl-2-acryloyloxyethyl phosphate, dioctyl-2-(meth)acryloyloxyethyl phosphate, and the like.

Here, a polymer component with an acidic group may form a salt structure by being turned into an ammonium salt before polymerization or after polymerization. Turning the polymer component into an ammonium salt can be realized, for example, by reacting an anionic group with tertiary amines or quaternary ammonium hydroxides.

Examples of polymer components with a hydroxyl group include hydroxyalkyl(meth)acrylate (for example, hydroxyethyl(meth)acrylate, hydroxypropyl(meth)acrylate, and the like), allyl alcohol, polyethylene glycol mono(meth)acrylate, and the like, and also those in which a monomer with a glycidyl group is copolymerized before being ring-opened, those in which an OH group is introduced by polymerizing before hydrolysizing a monomer with t-butoxy or the like, and the like.

### (Other Characteristics of Polymer Dispersant)

From the viewpoint of more easily improving the dispersion stability of the image display particles, the polymer dispersant according to the present exemplary embodiment preferably has the following polymerization ratio for each polymer component (monomer).

The polymerization ratio of the polymer component with a silicone chain is preferably from 10% by mole to 40% by mole with respect to all polymer components of the copolymer.

The polymerization ratio of the hydrophobic polymer component (the hydrophobic polymer component other than the polymer component with the silicone chain) is preferably from 20% by mole to 70% by mole with respect to all polymer components of the copolymer, and desirably from 25% by mole to 60% by mole.

The polymerization ratio of the polymer component with a polyalkylene glycol structure is preferably from 1% by mole to 30% by mole with respect to all polymer components of the copolymer.

The polymerization ratio of the hydrophilic polymer component (hydrophilic polymer component other than the polymer component with a polyalkylene glycol structure) is preferably from 1% by mole to 30% by mole with respect to all polymer components of the copolymer.

The weight-average molecular weight of the copolymer configuring the polymer dispersant according to the present exemplary embodiment is preferably from 3,000 to 1,000,000, desirably from 5,000 to 500,000, and more desirably from 10,000 to 100,000.

The number average molecular weight of the copolymer configuring the polymer dispersant according to the present exemplary embodiment is preferably from 3,000 to 500,000, desirably from 4,000 to 100,000, and more desirably from 5,000 to 50,000.

In the polymer dispersant according to the present exemplary embodiment, the ratio (Mw/Mn) between a weight-average molecular weight Mw and a number average molecular weight Mn is preferably from 1 to 5, desirably from 1.5 to 4.5, and more desirably from 1.5 to 4.

If each molecular weight of the polymer dispersant is within the ranges described above, the dispersion stability of the image display particles is more easily improved.

Here, each molecular weight is measured through size-exclusion column chromatography.

The polymer dispersant according to the present exemplary embodiment may be in a state of being physically attached (adsorbed) to charged particles (image display particles), or may be in a state of being chemically attached (bonded).

### (Manufacturing Method of Polymer Dispersant)

The polymer dispersant according to the present exemplary embodiment is synthesized using a known technique.

Specifically, for example, a solvent (for example, isopropyl alcohol (IPA) and the like) is placed in a reaction vessel equipped with a stirrer and a thermometer, and the polymer components (monomers) as the raw materials for synthesizing the dispersant and a polymerization initiator are added and dissolved. Nitrogen bubbling (for example, 100 ml per minute for 15 minutes) is performed on the solution, stirring with heating is continued (for example, for five hours at 55° C.) in a sealed state, and the reaction is ended. By evaporating the solvent from the obtained resin solution, a polymer dispersant containing a copolymer is obtained,

Here, as the polymerization initiator, for example, V-601, V-65, AIBN, or the like is used.

As the solvent, other than isopropyl alcohol (IPA) described earlier, methoxypropanol, tetrahydrofuran (THF), dimethyl silicone oil, or the like is used.

Here, adjustment of the ratio of each constituent unit of the polymer dispersant is made by an adjustment of the ratio of each monomer used in the polymerization.

### [Image Display Particles]

The image display particles according to the present exemplary embodiment are configured to include an image display particle main body and the polymer dispersant according to the present exemplary embodiment described above attached to the surface of the image display particle main body.

The image display particle main body include, for example, core particles and a covering layer covering the core particles. Here, the image display particle main body may have a configuration of not including a covering layer (a configuration of the core particles alone).

### (Core Particles)

The core particles include, for example, a resin (hereinafter referred to as the “resin of the core particles”) and a coloring agent. Here, the core particles may be configured by the particles with the coloring agent alone. However, in a case where the core particles are configured by the particles with the coloring agent alone, a covering layer is preferably included.

### —Resin of Core Particles—

From the viewpoint of the manufacturing method of the image display particles, the resin of the core particles is preferably a water-soluble resin or an alcohol-soluble resin. Here, water-soluble and alcohol-soluble denote 1% by mass or more of a target substance being dissolved in water or alcohol at 25° C.

The resin of the core particles may be a non-cross-linked resin or may be a cross-linked resin.

In order for the resin of the core particles to be a cross-linked resin, for example, there is a method of cross-linking the resin by adding a cross-linking agent separately from the resin. Here, examples of cross-linking agents include cross-linking agents such as a vinyl compound, an epoxy compound, a carbodiimide compound, and a water-dispersion type isocyanate.

The usage amount of the cross-linking agent in order to obtain a cross-linked resin is, for example, desirably from 0.1% by mass to 20% by mass with respect to the resin of the core particles, and more desirably from 0.5% by mass to 10% by mass.

While the resin of the core particles may be a charged resin (a resin including a charged group) or may be a non-charged resin (a resin not including a charged group), from the viewpoint of improving the charge amount, a charged resin is preferable.

That is, the resin of the core particles may be configured only by a non-charged resin or a charged resin, or may be configured by a mixture or a copolymer of a non-charged resin and a charged resin. However, in a case where the resin of the core particles is configured only by a non-charged resin, it is necessary to impart a charging property to the resin of the covering layer.

Examples of charged resins include a homopolymer of a polymer component with a charged group, a copolymer of a polymer component with a charged group and a polymer component without a charged group, and the like.

On the other hand, an example of a non-charged resin is a homopolymer of a polymer component without a charged group.

In a case where such copolymers are made to be cross-linked resins, a polymer component with a reactive group (cross-linking group) may be further copolymerized.

Here, each of the polymer components may be used alone, or two or more types may be used together.

Here, an example of a charged group (for example, a polar group; a polarized functional group) is a base or an acid.

Examples of bases (hereinafter, cationic groups) as charged groups include an amino group, a quaternary ammonium group, and the like (include the salts of such groups). Such cationic groups have a tendency, for example, of making particles positively charged.

Examples of acids (hereinafter anionic groups) as charged groups include a phenol group, a carboxylic group, a carboxylate group, a sulfonic acid group, a sulfonate group, a phosphoric acid group, a phosphate group, and a tetraphenyl boron group (including the salts of such groups). Such anionic groups have a tendency, for example, of making particles negatively charged.

In addition, examples of charged groups also include a fluorine group, a phenyl group, a hydroxyl group, and the like.

Each polymer component will be described below.

Here, in the following description, descriptions such as “(meth)acrylate” are expressions including both “acrylate” and “methacrylate”, and the like.

Examples of polymer components with a cationic group (hereinafter, cationic polymer components) include the following. Specifically, (meth)acrylates with an aliphatic amino group such as N,N-dimethyl aminoethyl(meth)acrylate, N,N-diethyl aminoethyl(meth)acrylate, N,N-dibutyl aminoethyl(meth)acrylate, N,N-hydroxyethyl aminoethyl(meth)acrylate, N-ethyl aminoethyl(meth)acrylate, N-octyl-N-ethyl aminoethyl(meth)acrylate, and N,N-dihexyl aminoethyl(meth)acrylate; aromatic substituted ethylene-based monomers with a nitrogenous group such as dimethyl aminostyrene, diethyl aminostyrene, dimethyl aminomethyistyrene, and dioctyl aminostyrene; nitrogen-containing vinyl ether monomers such as vinyl-N-ethyl-N-phenyl aminoethyl ether, vinyl-N-butyl-N-phenyl aminoethyl ether, triethanolamine divinyl ether, vinyldiphenyl aminoethyl ether, N-vinylhydroxyethyl benzamide, and m-aminophenylvinyl ether; pyrroles such as vinylamine and N-vinylpyrrole; pyrrolines such as N-vinyl-2-pyrroline and N-vinyl-3-pyrroline, pyrrolidines such as N-vinylpyrrolidine, vinylpyrrolidine aminoether, and N-vinyl-2-pyrrolidine; imidazoles such as N-vinyl-2-methylimidazole; imidazolines such as N-vinylimidazoline; indores such as N-binylindore; indolines such as N-vinylindoline; carbazoles such as N-viylcabazole and 3,6-dibromo-N-vinylcarbazole; pyridines such as 2-vinylpyrridine, 4-vinylpyrridine, and 2-methyl-5-vinylpyrridine; piperidines such as (meth)acrylpiperidine, N-vinylpiperidine, and N-vinylpiperazine; quinolines such as 2-vinylquionoline, 4-vinylquinoline, pyrazoles such as N-vinylpyrazole and N-vinylpyrazoline; oxazoles such as 2-vinyloxazole; oxazines such as 4-vinyloxazine and morpholinoethyl (meth)acrylate; and the like.

Here, the cationic polymer component may form a salt structure by being turned into a quaternary ammonium salt before polymerization or after polymerization. Turning a cationic polymer component into a quaternary ammonium salt is realized, for example, by reacting a cationic group with alkyl halides or ester tosylates.

Examples of polymer components with an anionic group (hereinafter, anionic polymer components) include a polymer component with a carboxylic group, a polymer component with a sulfate group, a polymer component with a phosphate group, and the like.

Examples of polymer components with a carboxylic group include (meth)acrylate, crotonic acid, itaconic acid, maleic acid, fumaric acid, citraconic acid, anhydrides thereof, monoalkyl esters or carboxyethylvinyl ethers thereof, vinyl ethers with a carboxylic group such as a carboxypropylvinyl ether, salts thereof, and the like.

Examples of polymer components with a sulfonate group include styrene sulfonate, 2-acrylamido-2-methylpropane sulfonate, 3-sulfopropyl (meth)acrylic acid ester, bis-(3-sulfopropyl)-itaconic acid ester, and the like, and salts thereof. Further, examples of polymer components with a sulfonate group also include sulfuric acid monoesters of 2-hydroxyethyl (meth)acrylates, and salts thereof.

Examples of polymer components with a phosphoric acid group include vinyl phosphonic acid, vinyl phosphate, acid phosoxyethyl(meth)acrylate, acid phosoxypropyl(meth)acrylate, bis(methacryloxyethyl)phosphate, diphenyl-2-methacryloyloxyethyl phosphate, diphenyl-2-acryloyloxyethyl phosphate, dibutyl-2-methacryloyloxyethyl phosphate, dibutyl-2-acryloyloxyethyl phosphate, dioctyl-2-(meth)acryloyloxyethyl phosphate, and the like.

Here, an anionic polymer component may form a salt structure by being turned into an ammonium salt before polymerization or after polymerization. Turning the anionic polymer component into an ammonium salt can be realized, for example, by reacting the anionic group with tertiary amines or quaternary ammonium hydroxides.

An example of a polymer component with a fluorine group is a (meth)acrylate monomer with a fluorine group, specific examples of which include trifluoroethyl(meth)acrylate, pentafluoropropyl(meth)acrylate, perfluoroethyl(meth)acrylate, perfluorobutylethyl(meth)acrylate, perfluorooctylethyl(meth)acrylate, perfluorodecylethyl(meth)acrylate, trifluoromethyl trifluoroethyl(meth)acrylate, hexafluorobutyl(meth)acrylate, and the like.

Examples of polymer components with a phenyl group include, styrene, phenoxyethylene glycol(meth)acrylate, phenoxypolyethylene glycol(meth)acrylate, 2-hydroxy-3-phenoxypropyl(meth)acrylate, phenoxyethylene glycol(meth)acrylate, and the like.

Examples of polymer components with a hydroxyl group include hydroxyalkyl(meth)acrylate (for example, hydroxyethyl(meth)acrylate, hydroxypropyl(meth)acrylate, and the like), allyl alcohol, polyethylene glycol mono(meth)acrylate, and the like, and in addition, examples include those in which a monomer with a glycidyl group is copolymerized before being ring-opened, an OH group is introduced by polymerizing before hydrolysizing a monomer with t-butoxy, or the like.

An example of a polymer component without a charged group is a non-ionic polymer component (nonionic polymer component), examples of which include (meth)acrylonitrile, alkyl ester(meth)acrylate, (meth)acrylamide, ethylene, propylene, butadiene, isoprene, isobutylene, N-dialky-substituted (meth)acrylamide, vinylcarbazole, vinyl chloride, vinylidene chloride, vinylpyrrolidone, and the like.

The weight-average molecular weight of the resin of the core particles is desirably from 1,000 to 1,000,000, and more desirably from 10,000 to 200,000.

### —Coloring Agent—

Organic or inorganic pigments, oil-soluble dyes, and the like are used as the coloring agent, examples of which include known coloring agents such as magnetic powders such as magnetite and ferrite, carbon black, titanium oxide, magnesium oxide, zinc oxide, a phthalocyanine copper-based cyan color material, an azo-based yellow color material, an azo-based magenta color material, a quinacridone-based magenta color material, a red color material, a green color material, and a blue color material. Specifically, typical examples of coloring agents include aniline blue, calco oil blue, chrome yellow, ultramarine blue, DuPont oil red, quinoline yellow, methylene blue chloride, phthalocyanine blue, malachite green oxalate, lamp black, rose bengal, C.I. pigment red 48:1, C.I. pigment red 122, C.I. pigment red 57:1, C.I. pigment yellow 97, C.I. pigment blue 15:1, C.I. pigment blue 15:3, and the like.

The mixing amount of the coloring agent is desirably from 10% by mass to 99% by mass with respect to the resin of the core particles, and more desirably from 30% by mass to 99% by mass.

### —Other Mixing Materials—

Other mixing materials may be included in the core particles.

Examples of other mixing materials include charge control materials and magnetic materials.

Known materials used as electrophotographic toner materials are used as the charge control material, examples of which include cetyl pyridyl chloride, quaternary ammonium salts such as BONTRON P-51, BONTRON P-53, BONTRON E-84, and BONTRON E-81 (all of which are manufactured by Orient Chemical Industries Co., Ltd.), a salicylic acid-based metallic complex, a phenol-based condensate, a tetraphenyl-based compound, metal oxide particles, and metal oxide particles that are surface-treated using various coupling agents.

An inorganic magnetic material or an organic magnetic material that is color coated as necessary is used as the magnetic material. Further, a transparent magnetic material, particularly a transparent organic magnetic material is more desirable since the coloring of the coloring pigment is not easily inhibited and the specific gravity is also low compared to an inorganic magnetic material.

An example of a colored magnetic powder (color coated material) is a small diameter colored magnetic powder described in JP-A-2003-131420. One including magnetic particles as the nucleus and a colored layer laminated on the surface of the magnetic particles is used. Further, while as the colored layer, an embodiment where magnetic powder is colored by pigment or the like so as to make the colored layer impermeable may be selected, using a light interference thin film, for example, is desirable. The light interference thin film is obtained by making an achromatic color material such as SiO₂ and TiO₂ a thin film with the same thickness as the wavelength of light, and light with a specific wavelength is selectively reflected through light interference caused in the thin film.

### (Covering Layer)

The covering layer is configured to include, for example, a resin (hereinafter referred to as the “resin of the covering layer”).

### —Resin of Covering Layer—

An example of a resin of the covering layer is a charged resin, and from the viewpoint of improving the dispersity of the image display particles, a polymer component with a silicone chain may be copolymerized as the polymer component of the resin.

A specific example of the resin of the covering layer is a resin formed of a copolymer of a polymer component with a silicone chain, a polymer component with a charged group, and other polymer components as necessary.

Here, the resin of the covering layer may be a non-crosslinked resin or may be a crosslinked resin.

Examples of methods of cross-linking the resin of the covering layer include a method of polymerizing a polymer component with a reactive group (crosslinking group) as the polymer component of the resin to cross-link the resin and a method of crosslinking the resin by adding a crosslinking agent separately from the resin. Here, examples of cross-linking agents include a vinyl compound, an epoxy compound, block isocyanate, and the like.

The polymer component with a silicone chain (monomer with a silicone chain) is the same as the polymer component with a silicone chain described as the polymer component of the polymer dispersant, for example.

The polymer component with a charged group is the same as the polymer component with a charged group described as the polymer component of the resin in the core particles.

Examples of other polymer components include polymer components without a charged group and polymer components with a reactive group.

Polymer components without a charge group are the same as the polymer components without a charged group described as a polymer component of the resin of the core particles.

Examples of polymer components with a reactive group (cross-linked group) include glycidyl (meth)acrylate including an epoxy group, an isocyanate-based monomer including an isocyanate group (for example, Showa Denko K.K.: Karenz AOI (2-isocyanate ethylacrylate), Karenz MOI (2-isocyanate ethymethacrylate)), an isocyanate-based monomer including a blocked isocyanate group (for example, Showa Denko K.K.: Karenz MOI-BM (2-(0-[1′-methylpropyridine amine]carboxyamino)ethyl), Karenz MOI-BP (2[(3,5-dimethyl pyrazolyl)carbonylamine]ethylmethacrylate)), and the like.

Here, the blocked isocyanate group is, for example, in a state in which the isocyanate group has reacted with a substituent, and is in a state in which the isocyanate group has reacted with a substituent to be eliminated through heating. In such a case, the reactivity of the isocyanate group is suppressed, and the isocyanate group is in a state of reacting as the substituent is eliminated through heating.

If a polymer component with a reactive group is used as a polymer component of the resin of such a covering layer, the resin itself of the covering layer is crosslinked, and the covering layer is configured by a crosslinked resin. Further, the covering layer covers the core particles in a state in which the reactive group of the resin of the covering layer is bonded to a functional group on the surface of the core particles.

In the resin of the covering layer, the polymer component with a silicone chain desirably has a molar ratio with respect to all polymer components (all polymer components) of from 1% by mole to 30% by mole, and more desirably from 5% by mole to 20% by mole.

In the resin of the covering layer, the polymer component with a charged group desirably has a molar ratio with respect to all polymer components (all polymer components) of from 1% by mole to 50% by mole, and more desirably from 10% by mole to 30% by mole.

In the resin of the covering layer, the polymer component with a reactive group desirably has a molar ratio with respect to all polymer components (all polymer components) of from 1% by mole to 40% by mole, and more desirably from 1% by mole to 30% by mole.

The weight-average molecular weight of the resin of the covering layer is desirably from 500 to 1,000,000, and more desirably from 1,000 to 1,000,000.

### —Other Mixing Materials—

Other mixing materials may be included in the covering layer.

Examples of other mixing materials include charge controlling agents, magnetic materials, and the like.

### —Characteristics of Covering Layer—

In the covering layer, the coverage amount on the surface of the core particles is, for example, from 0.5% by mass to 10% by mass with respect to the core particles, and desirably from 0.5% by mass to 5% by mass.

### (Characteristics of Image Display Particles)

While the average particle diameter (volume-average particle diameter) of the image display particles according to the present exemplary embodiment is, for example, from 0.1 μm to 10 μm. The average particle diameter is selected according to need, and is not limited thereto.

The average particle diameter is measured using Photal FPAR-1000 (dynamic light scattering type particle diameter distribution measuring device) manufactured by Otsuka Electronics Co., Ltd, and analysis is performed using a MARQUARDT method.

### (Manufacturing Method of Image Display Particles)

While the following manufacturing method is exemplified as a manufacturing method of the image display particles according to the present exemplary embodiment, the manufacturing method is not limited thereto.

First, the resin of the core particles, the coloring agent, and other mixing materials are mixed in a first solvent to prepare a mixed liquid in which the resin of the core particles is dissolved.

Here, the first solvent is a good solvent that can form a dispersed phase within a second solvent (poor solvent that can form a continuous phase) described later, and is selected from a solvent with a lower boiling temperature than the second solvent and in which the resin of the core particles is dissolved.

Examples of the first solvent include water, alcohols (for example, isopropyl alcohol (IPA)), methanol, ethanol, butanol, methoxypropanol, or the like), tetrahydrofuran, ethyl acetate, butyl acetate, and the like.

Next, the obtained mixed liquid is mixed with the second solvent and stirred, and the mixed liquid is emulsified with the second solvent as a continuous phase to prepare an emulsified liquid.

Furthermore, the first solvent within the emulsified liquid is removed (dried) through heating or the like to precipitate the resin of the core particles, and core particles (core particles dispersed in the second solvent) are obtained as granules including the resin, the coloring agent, and other mixing materials.

Here, the second solvent is a poor solvent that can form a continuous phase different from the first solvent forming dispersed phase, has a higher boiling temperature than the first solvent, and the resin of the core particles is selected from an insoluble solvent.

An example of the second solvent is a dispersing agent (dispersing agent including a silicone oil) for dispersing the obtained image display particles.

Furthermore, it is preferable to add the polymer dispersant according to the present exemplary embodiment described above as an emulsified dispersant to the second solvent.

Next, the resin of the covering layer and the other mixing materials are mixed in a third solvent to prepare a mixed liquid in which the resin of the covering layer is dissolved.

Here, the third solvent is also a good solvent that can form a dispersed phase within the second solvent (poor solvent that can form a continuous phase), has a lower boiling temperature than the second solvent, and is selected from a solvent that can dissolve the resin of the covering layer. Further, the third solvent is preferably selected from a solvent in which the resin of the core particles is insoluble.

Examples of the third solvent also include water, alcohols (for example, isopropyl alcohol (IPA), methanol, ethanol, butanol, methoxypropanol, or the like), tetrahydrofuran, ethyl acetate, butyl acetate, and the like.

Next, the obtained mixed liquid is mixed with the second solvent in which the core particles are dispersed, and stirred, and the mixed liquid is emulsified with the second solvent as a continuous phase to prepare an emulsified liquid.

Furthermore, the third solvent within the emulsified liquid is removed (dried) through heating or the like to precipitate the resin of the core particles on the surface of the core particles, and a covering layer including the resin and the other mixing materials is formed on the surface of the core particles.

A heating process for crosslinking the resin is then performed in a case where the core particles and the covering layer are a crosslinked resin.

Thus, image display particles in which the covering layer is formed on the surface of the core particles are obtained, and an image display particle dispersion liquid including the above is obtained.

Here, the obtained image display particle dispersion liquid may be diluted as necessary using dispersing agent (solvent), for example. Also, in order to obtain an image display particle dispersion liquid including two or more types of image display particles, dispersion liquids may be mixed after creating the respective dispersion liquids.

### [Image Display Particle Dispersion Liquid]

The image display particle dispersion liquid according to the present exemplary embodiment includes the dispersing agent and the image display particles according to the present exemplary embodiment dispersed in the dispersing agent.

The dispersing agent is configured to include a silicone oil. Naturally, the dispersing agent may be a mixed solvent of a silicone oil and a solvent other than a silicone oil. However, in the case of a mixed solvent, 50% by mass or more of the silicone oil is preferably included as the main solvent.

Specific examples of silicone oils include silicone oils in which a hydrocarbon group is bonded to a siloxane bond (for example, dimethyl silicone oil, diethyl silicone oil, methylethyl silicone oil, methylphenyl silicone oil, diphenyl silicone oil, and the like). Of the above, dimethyl silicone is particularly desirable.

Further, examples of solvents other than a silicone oil include other petroleum-based high boiling temperature solvents such as a paraffin-based hydrocarbon solvent or a fluorine-based liquid.

An acid, an alkali, a salt, a dispersant, a dispersion stabilizer, a stabilizer with the aim of preventing oxidization, absorbing ultraviolet rays, or the like, an antimicrobial, a preservative, and the like may be added to the image display particle dispersion liquid according to the present exemplary embodiment. Further, a charge controlling agent may be added to the image display particle dispersion liquid according to the present exemplary embodiment.

While various concentrations of the image display particles within the image display particle dispersion liquid according to the present exemplary embodiment are selected according to the display characteristics, response characteristics, or the needs thereof, a range of from 0.1% by mass to 30% by mass is desirably selected. In a case where particles with different colors are mixed, the total particle amount thereof is desirably within the range.

The image display particle dispersion liquid according to the present exemplary embodiment is used as a display medium of an image display form, a photochromatic medium (photochromatic element) of an image display form, a liquid toner of a liquid developing form electrophotographic system, and the like. Here, as the display medium of an image display form and the photochromatic medium (photochromatic element) of an image display form, there is a known form of moving a particle group in the opposing direction of an electrode (substrate) face, a different form of moving in a direction along an electrode (substrate) face (so-called in-plane type element), and a hybrid element of combining the above.

Here, in the image display particle dispersion liquid according to the present exemplary embodiment, if a plurality of types of particles with different colors and charge polarities are mixed and used as the image display particles, a color display is realized.

### [Display Medium, Display Device]

An example of the display medium and display device according to the embodiment will be described below.

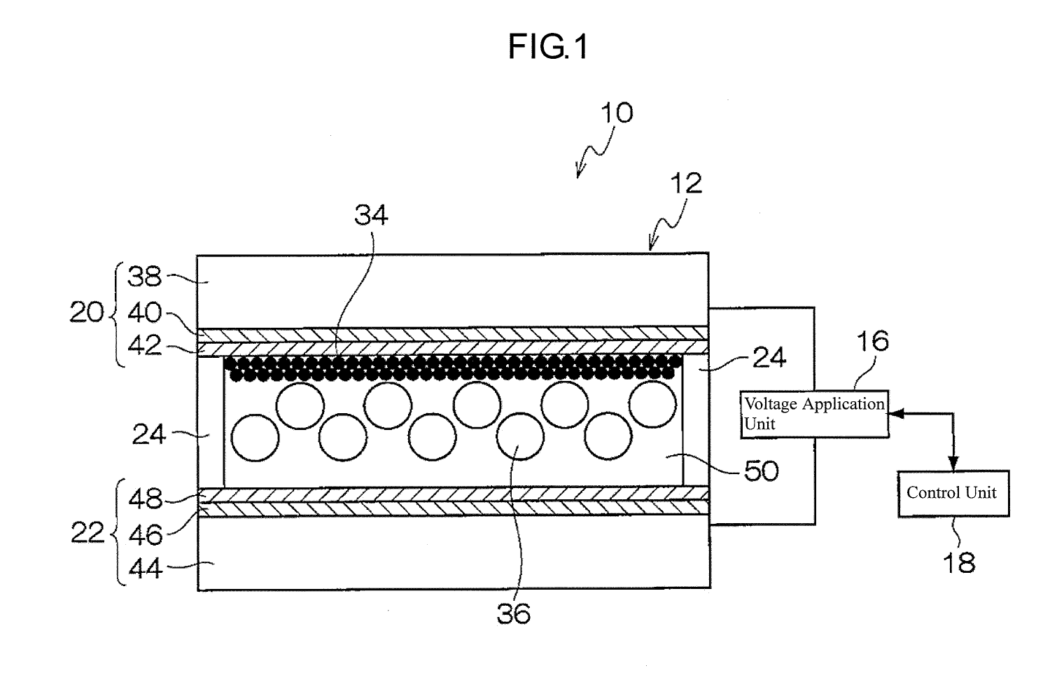

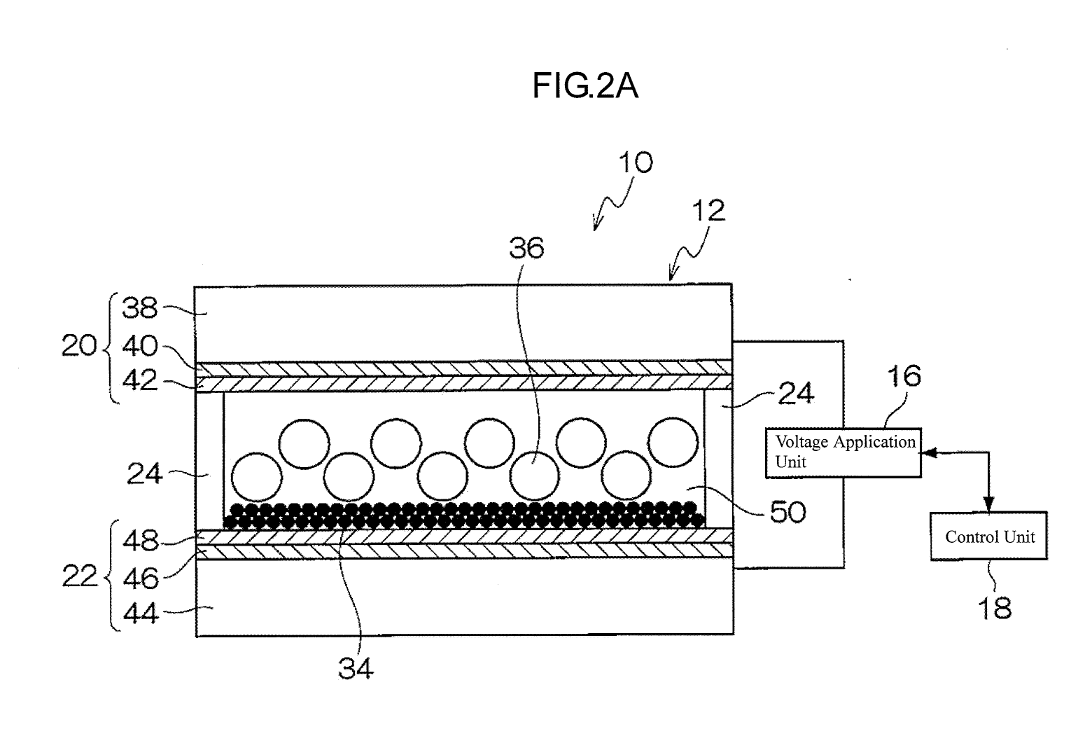

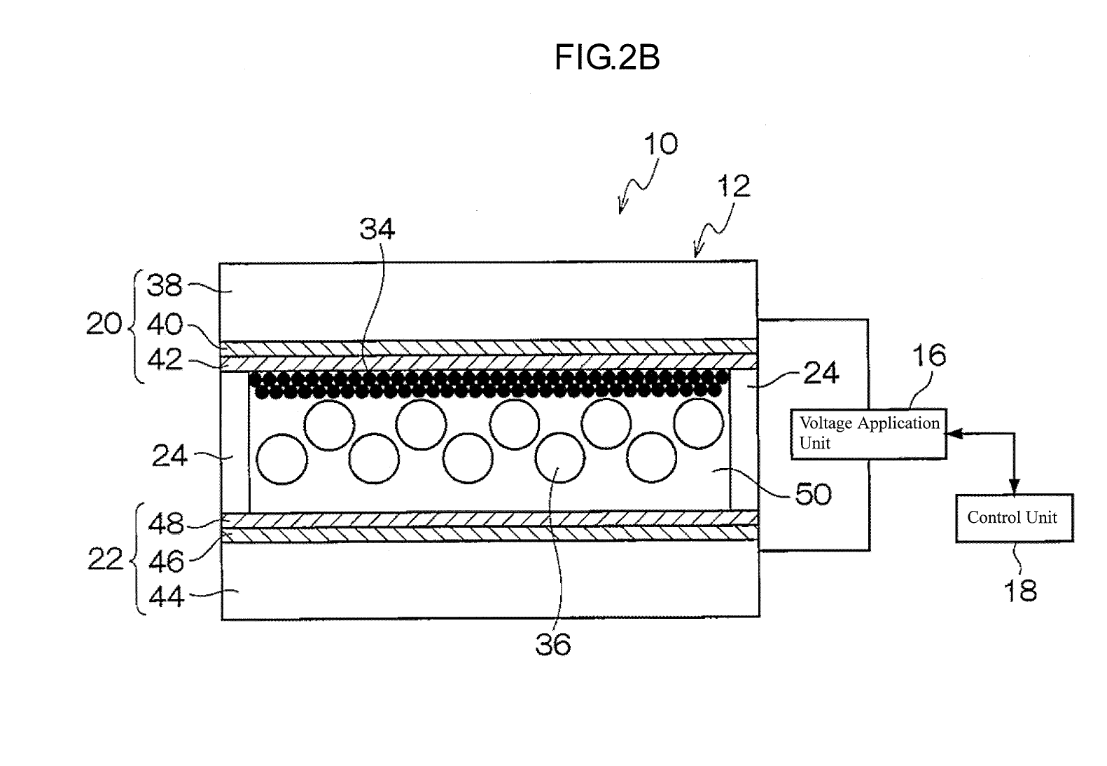

FIG. 1 is an outline configuration view of a display device according to the present exemplary embodiment. FIG. 2 is an explanatory diagram schematically illustrating the movement state of a particle group when a voltage is applied between the substrates of a display medium of the display device according to the present exemplary embodiment.

A display device 10 according to the present exemplary embodiment has a form of applying the image display particle dispersion liquid according to the present exemplary embodiment described above as a particle dispersion liquid including a dispersing agent 50 and a particle group 34 of a display medium 12 thereof. That is, the display device 10 has a form in which the image display particles according to the present exemplary embodiment as the particle group 34 are dispersed in the dispersing agent 50.

As illustrated in FIG. 1, the display device 10 according to the present exemplary embodiment is configured to include the display medium 12, a voltage application unit 16 that applies a voltage to the display medium 12, and a control unit 18.

The display medium 12 is configured to include a display substrate 20 as an image display face, a reverse substrate 22 opposing the display substrate 20 with a gap therebetween, a gap member 24 maintaining a specified gap between the substrates and dividing the gap between the display substrate 20 and the reverse substrate 22 into a plurality of cells, and a reflection particle group 36 with different optical reflection characteristics from a particle group 34 sealed within each cell.

The cell described above indicates a region surrounded by the display substrate 20, the reverse substrate 22, and the gap member 24. A dispersing agent 50 is sealed within the cell. The particle group 34 is configured by a plurality of particles, is dispersed within the dispersing agent 50, and moves between the display substrate 20 and the reverse substrate 22 through a gap of the reflection particle group 36 according to the strength of an electric field formed within the cell.

Here, by providing the gap member 24 to correspond with each pixel when an image is displayed on the display medium 12 and forming cells to correspond to each pixel, the display medium 12 may be configured to perform display for each pixel.

Further, in the present exemplary embodiment, in order to simplify description, the present exemplary embodiment will be described using a view concentrating on one cell. Details of each configuration will be described below.

First, the pair of substrates will be described.

The display substrate 20 has a configuration of laminating a surface electrode 40 and a surface layer 42 in order on a support substrate 38. The reverse substrate 22 has a configuration of laminating a reverse electrode 46 and a surface layer 48 on a support substrate 44.

The display substrate 20 or both the display substrate 20 and the reverse substrate 22 are light transmissive. Here, light transmissive in the present exemplary embodiment refers to a transmissivity of visible light of 60% or more.

Examples of the materials of the support substrate 38 and the support substrate 44 include glass and plastics such as a polyethylene terephthalate resin, a polycarbonate resin, an acrylic resin, a polyimide resin, a polyester resin, an epoxy resin, a polyether sulfonic resin, and the like.

Examples of the materials of the surface electrode 40 and the reverse electrode 46 include oxides of indium, tin, cadmium, and antimony, complex oxides such as ITO, metals such as gold, silver, copper, and nickel, organic materials such as polypyrrole and polythiophene, and the like. The surface electrode 40 and the reverse electrode 46 may be any of a single layer film, a mixed film, or a complex film thereof. The thickness of the surface electrode 40 and the reverse electrode 46 is preferably from 100 Å to 2000 Å. The reverse electrode 46 and the surface electrode 40 may be formed, for example, in a matrix pattern or a striped pattern.

Further, the surface electrode 40 may be embedded into the support substrate 38. Further, the reverse electrode 46 may be embedded into the support substrate 44. In such a case, the materials of the support substrate 38 and the support substrate 44 are selected according to the composition or the like of each particle of the particle group 34.

Here, each of the reverse electrode 46 and the surface electrode 40 may be separated from the display substrate 20 and the reverse substrate 22 respectively and arranged on the outside of the display medium 12.

Here, while a case where an electrode (the surface electrode 40 and the reverse electrode 46) has been included on both the display substrate 20 and the reverse substrate 22 has been described above, an electrode may be provided on only one of the substrates and driven as an active matrix.

Further, in order to perform active matrix driving, the support substrate 38 and the support substrate 44 may include a TFT (Thin Film Transistor) for each pixel. The TFT may be included not on the display substrate but on the reverse substrate 22.

Next, the surface layer will be described.

The surface layer 42 and the surface layer 48 are formed on each of the surface electrode 40 and the reverse electrode 46. Examples of materials configuring the surface layer 42 and the surface layer 48 include polycarbonate, polyester, polyethylene, polyimide, epoxy, polyisocyanate, polyamide, polyvinyl alcohol polybutadiene, polymethyl methacrylate, a copolymer nylon, an ultraviolet curable acrylic resin, a fluorine resin, and the like.

The surface layer 42 and the surface layer 48 may be configured to include the resin described above and a charge transport substance, or may be configured to include a self-supporting resin with charge transportability.

Next, the gap member will be described.

The gap member 24 for maintaining a gap between the display substrate 20 and the reverse substrate 22 is configured by a thermoplastic resin, a thermosetting resin, an electron beam curable resin, a light curable resin, rubber, a metal, or the like.

The gap member 24 may be integrated with either one of the display substrate 20 and the reverse substrate 22. In such a case, the support substrate 38 or the support substrate 44 is created by performing an etching process of etching the support substrate 38 or the support substrate 44, a laser treatment process, a press treatment process using a mold created in advance, a printing process, or the like.

In such a case, the gap member 24 is created on either or both of the display substrate 20 side and the reverse substrate 22 side.

While the gap member 24 may be colored or colorless, colorless and transparent is preferable, and in such a case, the gap member 24 is configured by a transparent resin such as, for example, polystyrene, polyester, or acryl, or the like.

Further, a granular gap member 24 is also desirably transparent, and in addition to transparent resins such as polystyrene, polyester, and acryl, glass particles are also used.

Here, “transparent” refers to a transmissivity of 60% or more with respect to visible light.

Next, the reflection particle group will be described.

The reflection particle group 36 is configured by reflection particles with different optical reflection characteristics from the particle group 34, and functions as a reflection member displaying a different color from the particle group 34. Furthermore, the reflection particle group 36 also has a function as a void member of moving the display substrate 20 and the reverse substrate 22 without hindering movement between the substrates. That is, each particle of the particle group 34 passes through the gap of the reflection particle group 36 and moves from the reverse substrate 22 side to the display substrate 20 side or from the display substrate 20 side to the reverse substrate 22 side. While white or black, for example, may be selected as the color of the reflection particle group 36 to be the background color, a different color is also possible. Further, the reflection particle group 36 may be a non-charged particle group (that is, a particle group that does not move according to an electric field), or may be a charged particle group (a particle group that moves according to an electric field). Here, while a case where the reflection particle group 36 is a non-charged white particle group is described in the present exemplary embodiment, the invention is not limited thereto.

Examples of the particles of the reflection particle group 36 include particles in which a white pigment (for example, titanium oxide, silicon oxide, zinc oxide, and the like) is dispersed in a resin (for example, a polystyrene resin, a polyethylene resin, a polypropylene resin, a polycarbonate resin, a polymethyl methacrylate resin (PMMA), an acrylic resin, a phenol resin, a formaldehyde condensate, and the like) and resin particles (for example, polystyrene particles, polyvinyl naphthalene particles, bismelamine particles, and the like). Further, in a case where particles of a color other than white are applied as the particles of the reflection particle group 36, for example, a pigment of a desired color or the resin particles described above containing a dye may be used. Examples of pigments and dyes in RGB or YMC colors include generic pigments and dyes used in printing ink and color toners.

Sealing the reflection particle group 36 between the substrates is performed using an ink jet method or the like. Further, in a case where the reflection particle group 36 is fixed, for example, by heating (and if necessary, pressurizing) the reflection particle group 36 after sealing and melting the particle group surface layer of the reflection particle group 36, sealing is performed while maintaining the particle gap.

Next, other configurations of the display medium will be described.

The size of the cell of the display medium 12 has a close relationship with the resolution of the display medium 12, and the smaller the cell, the greater the resolution of an image that can be displayed by the display medium 12 to be created, and normally, the length of the display medium 12 in the plate face direction of the display substrate 20 is approximately from 10 μm to 1 mm.

Here, the content (mass %) of the particle group 34 with respect to the total mass within the cell is not particularly limited as long as it is a concentration with which the desired color phase is obtained, and adjusting the content through the thickness of the cell (that is, the distance between the display substrate 20 and the reverse substrate) is effective for the display medium 12. That is, in order to obtain the desired color phase, the thicker the cell, the smaller the content, and the thinner the cell, the greater the content. Generally, the content is from 0.01% by mass to 50% by mass.

In order to fix the display substrate 20 and the reverse substrate 22 to each other via the gap member 24, a fixing method such as a combination of bolts and nuts, clamps, clips, and substrate fixing frames is used. Further, a fixing method such as an adhesive, heat melting, and ultrasonic bonding may also be used.

The display medium 12 configured in such a manner is used, for example, in a bulletin board on which an image can be saved and rewritten, a circular notice, an electric blackboard, an advertisement, a sign, a flashing label, electronic paper, an electronic newspaper, an electronic book, a document sheet in which a copier and a printer are combined, and the like.

As described above, the display device 10 according to the present exemplary embodiment is configured to include the display medium 12, the voltage application unit 16 that applies a voltage to the display medium 12, and the control unit 18 (refer to FIG. 1).

The voltage application unit 16 is electrically connected to the surface electrode 40 and the reverse electrode 46. Here, while a case where both the surface electrode 40 and the reverse electrode 46 are electrically connected to the voltage application unit 16 is described in the present exemplary embodiment, a configuration in which one of the surface electrode 40 and the reverse electrode 46 is grounded and the other is connected to the voltage application unit 16 is also possible.

The voltage application unit 16 is connected to the control unit 18 to transmit and receive signals.

The control unit 18 may be configured as a microcomputer including a CPU (Central Processing Unit) controlling the operation of the entire device, a RAM (Random Access Memory) temporarily storing various pieces of data, and a ROM (Read Only Memory) in which various programs such as a control program controlling the entire device are stored in advance.

The voltage application unit 16 is a voltage application device for applying a voltage to the surface electrode 40 and the reverse electrode 46, and applies a voltage according to the control of the control unit 18 between the surface electrode 40 and the reverse electrode 46.

Next, the operation of the display device 10 will be described. The operation will be described according to the operation of the control unit 18.

Here, a case where the particle group 34 sealed in the display medium 12 is positively charged will be described. Further, description will be given with the dispersing agent 50 as being transparent and the reflection particle group 36 as being white. That is, in the present exemplary embodiment, a case where the display medium 12 displays a color according to the movement of the particle group 34 and white is displayed as a background color thereof by the reflection particle group 36 will be described.

Here, for convenience of description, the following operation will be described regarding the operation from a state in which the particle group 34 is attached to the reverse substrate 22 side.

First, an operation signal indicating that a voltage is to be applied for a specified amount of time so that the surface electrode 40 is negative and the reverse electrode 46 is positive is output to the voltage application unit 16. From the state illustrated in FIG. 2(A), if the voltage applied between the electrodes is raised and a voltage of a threshold value or higher at which the surface electrode 40 is negative and a concentration change ends is applied, the particles configuring the positively charged particle group 34 move to the display substrate 20 side in a state in which the cohesive power of the particle group 34 is decreased and reach the display substrate 20 (refer to FIG. 2(B)).

Furthermore, when the application between the electrodes is ended, the particle group 34 is bound to the surface substrate 20 side, and the color of the particle group 34 is visible as the color of the display medium 12 which is visible from the display substrate 20 side, with the white as the color of the reflection particle group 36 as the background color.

Next, an operation signal indicating that a voltage is to be applied between the surface electrode 40 and the reverse electrode 46 for a specified amount of time so that the surface electrode 40 is positive and the reverse electrode 46 is negative is output to the voltage application unit 16. If the voltage applied between the electrodes is raised and a voltage of a threshold voltage or higher at which the surface electrode 40 is positive and a concentration change ends is applied, the particles configuring the positively charged particle group 34 move to the reverse substrate 22 side in a state in which the cohesive power of the particle group 34 is decreased and reach the reverse substrate 22 (refer to FIG. 2(A)).

Furthermore, when the application between the electrodes is ended, while the particle group 34 is bound to the reverse substrate 22 side, the white as the color of the reflection particle group 36 is visible as the color of the display medium 12 which is visible from the display substrate 20 side. Here, the particle group 34 is obscured by the reflection particle group 36 and is not easily visible.

Here, the voltage application time between the electrodes may be stored as information indicating the voltage application time in the voltage application during the operation in a memory or the like such as a ROM (not shown) placed in the control unit 18 in advance. Furthermore, the information indicating the voltage application time may be read when the processing is executed.

In such a manner, in the display device 10 according to the present exemplary embodiment, display is performed by the particle group 34 reaching the display substrate 20 or the reverse substrate 22 and being attached and aggregated.

Here, while a form in which the surface electrode 40 is provided on the display substrate 20 and the reverse electrode 46 is provided on the reverse substrate 22 and a voltage is applied between the electrodes (that is, between the substrates) to move the particle group 34 between the substrates to perform a display has been described in the display medium 12 and the display device 10 according to the present exemplary embodiment, without being limited thereto, and for example, a form in which the surface electrode 40 is provided on the display substrate 20 and an electrode is provided on the gap member and a voltage is applied between the electrodes to move the particle group 34 between the display substrate 20 and the gap member to perform a display is also possible.

Further, while a form in which one type (one color) of particle group is applied has been described in the display medium 12 and the display device 10 according to the present exemplary embodiment, without being limited thereto, a form in which two or more types (two or more colors) of particle groups are applied in combinations of different charge polarities or different threshold voltages is also possible.

Specifically, for example, there is a form in which a positively charged first particle group, a negatively charged second particle group, and a positively charged third particle group with a different threshold voltage to the particles of the first particle group and with a greater particle diameter are applied.

### EXAMPLES

The present invention will be described more specifically below using examples. The present invention will be described more specifically below using examples. However, each example is not to limit the present invention. Here, in the description, unless there is particular notice, “parts” and “%” denote “parts by mass” and “% by mass”.

### Example 1

“Silaplane FM-0711 (manufactured by JINC Corporation)” as a polymer component with a silicone chain, methyl methacrylate as a hydrophobic polymer component, methoxypoly(ethylene glycol)9methacrylate (manufactured by Shin-Nakamura Chemical Co., Ltd.) as a polymer component with a polyalkylene glycol structure, and methacrylic acid as a hydrophilic polymer component are dissolved in 1-methoxy-2-propanol with a molar ratio (mol %) with respect to all polymer components in accordance with Table 1, a ratio with respect to all polymer components of 1.5 mol % of a polymerization initiator (dimethyl-2,2′-azobis(2-methylpropionate) “V-601” manufactured by Wako Pure Chemical Industries, Ltd.) is dissolved thereto, oxygen is removed through nitrogen bubbling, and polymerization is performed for six hours at 80° C. After the polymerization, a purification process and drying are performed to obtain a polymer dispersant (1).

### Examples 2 to 11, Comparative Examples 1 to 7

Each polymer dispersant is obtained according to Table 1 in a similar manner to the polymer dispersant (1) of Example 1 except that the polymer components and the ratios thereof are changed.

However, in Comparative Example 7, “KF-6028 (manufactured by Shin-Etsu Chemical Co., Ltd.”) is adopted as the comparative polymer dispersant (7).

### [Evaluation]

Measuring of the molecular weight and emulsification stability evaluation is performed for the polymer dispersant obtained in each example.

### —Molecular Weight—

The weight-average molecular weight (expressed as Mw) and the number average molecular weight (expressed as Mn) of the polymer dispersants are measured using size-exclusion column chromatography.

### —Emulsification Stability Evaluation—

The emulsification stability evaluation is performed as follows. 0.05 g of a dispersed phase is added to 2 g of a silicone oil in which 1% by mass of a polymer dispersant is dissolved, the state immediately after performing ultrasonic irradiation using an ultrasonic washer (within a range of from 30° C. to 35° C.) for three minutes is observed using a microscope, and evaluation of the dispersity and stability are carried out.

The evaluation standards are as follows.

### —Dispersion Evaluation (Particle Diameter Evaluation)—

A: particle diameter of less than 10 μm
B: particle diameter of less than 20 μm and 10 μm or more
C: particle diameter of less than 50 μm and 20 μm or more
D: granulation not possible, or particle diameter is 50 μm or more

### —Stability Evaluation—

A: capable of being redispersed after one day through shaking
B: no aggregation after one minute when observed with a microscope
C: one or more instances of aggregation after one minute when observed with a microscope
D: pelletization not possible

### Example 101

An aqueous dispersion liquid is prepared by adding water to 50 parts by mass of a styrene/acrylic-based resin X345 (manufactured by Seiko PMC Corporation) as the resin of the core particles and 50 parts by mass of a cyan pigment (“H525F (manufactured by Sanyo Color Works, Ltd.)”) as the coloring agent so that the resin of the core particles and the coloring agent are 15% by mass of the whole.

Next, a silicone oil solution is prepared by adding 1 part by mass of the polymer dispersant (1) to 99 parts by mass of a silicone oil (“KF-96-2CS (manufactured by Shin-Etsu Chemical Co., Ltd.)”).

Next, with the obtained aqueous dispersion liquid as a dispersed phase and the silicone oil solution as a continuous phase, the two are mixed with a mass ratio (continuous phase:dispersed phase) of 10:1 and emulsification is performed using a homogenizer to prepared an emulsified liquid.

Next, the dispersion liquid of the core particles is obtained by drying the obtained emulsified liquid for six hours at 60° C. using an evaporator and removing the water in the emulsified liquid. The obtained core particles have an average particle diameter of 0.6 μm with a C.V. value (index indicating monodispersity: Coefficient of Variation: CV [%]=(σ/D)×100 (σ: standard deviation, D: average particle diameter)) of 25%.

Next, 10% by mass of a core particle dispersion liquid is prepared with the core particles dispersed in the liquid using a silicone oil.

Next, a copolymer of “Silaplane FM-0721 (manufactured by JMC Corporation)” as a polymer component with a silicone chain, phenoxypolyethylene glycol acrylate AMP-10G (manufactured by Shin-Nakamura Chemical Co., Ltd.) as a polymer component with a charged group, HEMA (2-hydroxyethyl methacrylate), and an isocyanate-based monomer (an isocyanate-based monomer “Karenz MOI-BP (manufactured by Showa Denko K.K.)” including a blocked isocyanate group) (molar ratio of 3/26/69/2) is prepared. The copolymer is the resin of the covering layer.

Next, 2 g of the resin of the covering layer are added to t-butanol to prepare 10% by mass of a solution (hereinafter, t-butanol 10% by mass solution).

Next, after sequentially adding 10 g of t-butanol, 20 g of a t-butanol 10% by mass solution, and 18 g of a silicone oil to 10 g of the core particle dispersion liquid with a dropwise speed of 2 ml/s and stirring the mixture, the mixture is dried for one hour at 50° C. using an evaporator to remove the t-butanol in the core particle dispersion liquid to precipitate the core particles in the resin of the covering layer to obtain granules in which the covering layer is formed on the surface of the core particles.

Next, the particle dispersion liquid is heated for one hour at 130° C. to crosslink the resin configuring the core particles and the covering layer.

After cooling, after centrifuging the obtained particle suspension for fifteen minutes at 6,000 rpm to remove the supernatant liquid, a washing process of redispersing using a silicone oil is repeated three times. 0.6 g of particles is thus obtained.

Through the process described above, an image display particle main body in which a covering layer is formed on the surface of the core particles and an image display particle dispersion liquid in which a polymer dispersant is attached to the image display particle main body is obtained.

TABLE 1

| | | Polymer | | Polymer | | | | | | | |
|---|---|---|---|---|---|---|---|---|---|---|---|
| | | component | Hydrophobic | component | | | | | | | |
| | | with silicone | polymer | with polyalkylene | Hydrophilic polymer | | | | | | |
| | | chain | component | glycol structure | component | | | | | | |
| Example | Polymer | Type/ | Type/ | Type/ | Type/ | Type/ | | | Mw/ | Disper- | Stabil- |
| No. | dispersant no. | mol % | mol % | mol % | mol % | mol % | Mw | Mn | Mn | sity | ity |
| Ex. 1 | Dispersant (1) | FM-0711/15 | MMA/65 | M-90G/5 | MAA/15 | — | 41,320 | 15,640 | 2.6 | A | B |
| Ex. 2 | Dispersant (2) | FM-0711/15 | MMA/65 | M-90G/10 | MAA/10 | — | 37,200 | 15,160 | 2.5 | A | B |
| Ex. 3 | Dispersant (3) | FM-0711/15 | MMA/65 | M-90G/20 | — | — | 41,900 | 17,800 | 2.4 | A | B |
| Ex. 4 | Dispersant (4) | FM-0711/25 | MMA/55 | M-90G/10 | MAA/10 | — | 36,400 | 17,400 | 2.1 | A | A |
| Ex. 5 | Dispersant (5) | FM-0711/25 | MMA/50 | M-90G/10 | MAA/15 | — | 45,920 | 27,620 | 1.7 | A | A |
| Ex. 6 | Dispersant (6) | FM-0711/25 | MMA/60 | M-90G/10 | MAA/5 | — | 45,900 | 27,600 | 1.7 | A | A |
| Ex. 7 | Dispersant (7) | FM-0711/25 | MMA/45 | M-90G/10 | MAA/20 | — | 47,100 | 16,500 | 2.9 | A | A |
| Ex. 8 | Dispersant (8) | FM-0711/25 | MMA/50 | M-90G/10 | MAA/10 | HEMA/5 | 42,900 | 14,300 | 3.0 | B | A |
| Ex. 9 | Dispersant (9) | FM-0711/25 | MMA/45 | M-90G/10 | MAA/10 | HEMA/10 | 32,100 | 13,000 | 2.5 | A | A |
| Ex. 10 | Dispersant (10) | FM-0711/25 | MMA/55 | M-90G/10 | — | HEMA/10 | 42,900 | 14,300 | 3.0 | A | A |
| Ex. 11 | Dispersant (11) | FM-0711/25 | MMA/25 | M-90G/10 | MAA/10 | HEMA/30 | 32,100 | 13,000 | 2.5 | A | A |
| Comp. | Comparative | FM-0711/68 | MMA/22 | — | MAA/10 | — | 910,000 | 240,000 | 3.8 | B | C |
| Ex. 1 | Dispersant (1) | | | | | | | | | | |
| Comp. | Comparative | FM-0711/68 | MMA/20 | — | MAA/12 | — | 1,080,000 | 310,000 | 3.5 | B | C |
| Ex. 2 | Dispersant (2) | | | | | | | | | | |
| Comp. | Comparative | FM-0711/15 | MMA/55 | — | MAA/30 | — | 55,860 | 16,890 | 3.3 | D | B |
| Ex. 3 | Dispersant (3) | | | | | | | | | | |
| Comp. | Comparative | FM-0711/15 | MMA/65 | — | MAA/20 | — | 43,200 | 14,770 | 2.9 | C | B |
| Ex. 4 | Dispersant (4) | | | | | | | | | | |
| Comp. | Comparative | FM-0711/20 | MMA/60 | — | MAA/20 | — | 50,800 | 19,500 | 2.6 | C | B |
| Ex. 5 | Dispersant (5) | | | | | | | | | | |
| Comp. | Comparative | FM-0711/25 | MMA/55 | — | MAA/20 | — | 36,650 | 18,450 | 2.0 | C | B |
| Ex. 6 | Dispersant (6) | | | | | | | | | | |

| | | | | |
|---|---|---|---|---|
| Comp. | Comparative | KF-6028 | A | D |
| Ex. 7 | Dispersant (7) | | | |

From the above results, it can be seen that in Examples 1 to 11, compared to comparative Examples 1 to 7, the emulsification stability is high.

Further, it can be seen that in Example 101, pelletization of the core particles is realized, and the dispersion stability of the image display particles is high.

Here, the details of the abbreviations and the like in Table 1 are as follows.

—Polymer Component with Silicone Chain—
FM-0711: “Silaplane FM-0711 (manufactured by JNC Corporation)”, weight-average molecular weight Mw=1,000, Structural Formula 1 [R₁=methyl group, R₁′=methyl group, n=10, x=3]
—Hydrophobic Polymer Component—
MMA: methyl methacrylate
   —Polymer Component with Polyalkylene Glycol Structure—
M-90G: methoxypoly(ethylene glycol)9methacrylate “NK ester M-90G manufactured by (Shin-Nakamura Chemical Co., Ltd.)”, weight-average molecular weight Mw=468

### —Hydrophilic Polymer Component—

MAA: methacrylate
HEMA (2-hydroxyethyl methacrylate)

### —Others—

KF-06028: silicone-based polymer dispersant “KF-06028 (manufactured by Shin-Etsu Chemical Co., Ltd.)” in which a graft chain of a polyethyleneoxy group is linked to a silicone main chain”

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. A polymer dispersant for image display particles, comprising a copolymer having a repeating unit corresponding to a polymer component with a silicone chain, a repeating unit corresponding to a hydrophobic polymer component other than the polymer component with a silicone chain, and a repeating unit corresponding to a polymer component with a polyalkylene glycol structure.

2. The polymer dispersant for image display particles according to claim 1,
wherein a polymerization ratio of the repeating unit corresponding to the polymer component with the silicone chain is from 10% by mole to 40% by mol with respect to all polymer components of the copolymer,
a polymerization ratio of the repeating unit corresponding to the hydrophobic polymer component is from 20% by mole to 70% by mole with respect to all polymer components of the copolymer, and
a polymerization ratio of the repeating unit corresponding to the polymer component with the polyalkylene glycol structure is from 1% by mole to 30% by mole with respect to all polymer components of the copolymer.

3. The polymer dispersant for image display particles according to claim 1,
wherein the copolymer further has a repeating unit corresponding to a hydrophilic polymer component other than the polymer component with the polyalkylene glycol component.

4. Image display particles comprising:
an image display particle main body; and
the polymer dispersant for image display particles according to claim 3, attached on a surface of the image display particle main body.

5. An image display particle dispersion liquid comprising:
a dispersing agent including a silicone oil; and
the image display particles according to claim 4 dispersed in the dispersing agent.

6. A display medium comprising:
a pair of substrates with at least one of the substrates being light-transmissive; and
the image display particle dispersion liquid according to claim 5 sealed between the pair of substrates.

7. A display medium comprising:
a pair of electrodes with at least one of the electrodes being light-transmissive; and
an area containing the image display particle dispersion liquid according to claim 5 provided between the pair of electrodes.

8. A display device comprising:
the display medium according to claim 6; and
a voltage application unit that applies a voltage between the pair of substrates.

9. A display device comprising:
the display medium according to claim 7; and
a voltage application unit that applies a voltage between the pair of electrodes of the display medium.
